(19) United States
(12) Patent Application Publication
(10) Pub. No.: US 2019/0192973 A1
(43) Pub. Date: Jun. 27, 2019

(54) INFORMATION PROCESSING DEVICE, METHOD OF GAME PROCESSING, AND INFORMATION PROCESSING SYSTEM

(71) Applicant: Kabushiki Kaisha Sega Games doing business as Saga Games Co., Ltd., Tokyo (JP)

(72) Inventors: Daisuke Kubota, Tokyo (JP); Hiroyasu Tamura, Tokyo (JP)

(73) Assignee: Kabushiki Kaisha Sega Games doing business as Sega Games Co., Ltd., Tokyo (JP)

(21) Appl. No.: 16/291,665

(22) Filed: Mar. 4, 2019

Related U.S. Application Data
(63) Continuation of application No. PCT/JP2017/036893, filed on Oct. 11, 2017.

(30) Foreign Application Priority Data
Dec. 2, 2016 (JP) 2016-235444

(51) Int. Cl. A63F 13/67; A63F 13/822; A63F 13/58

(52) U.S. Cl. CPC A63F 13/67; A63F 13/58; A63F 13/822

(57) ABSTRACT

An information processing device includes a memory, a transceiver receiving an input from a terminal device operated by a player in a game, and a controller. The memory stores usage frequency of game media used by players for each of the game media, game media in a possessed state for each of the players, a quantity of game items owned by each of the players, first and second quantities of game items for each of the game media. The input causes the game media in the possessed state to be put into a non-possessed state. The controller puts the game media into the possessed state upon detecting consumption of the first quantity from the quantity. The controller adds the second quantity to the quantity upon detecting the input. The controller determines the first and second quantities. The lower the usage frequency, the lower the first and second quantities.

### BACKGROUND

### Technical Field

One or more embodiments of the present invention relate to an information processing device, a method of game processing, and an information processing system.

### Related Art

Card games that are played in individual or team battle format using cards such as trading cards, for example, have become ubiquitous. In a card game, a player brings a bundle (deck) of cards selected from among the cards possessed by the player, and uses the cards in the deck to play the game.

Conventional card games have been played face-to-face by players using paper cards. The same kinds of card games have been played on game machines or computers (see, for example, Patent Literature 1).

Patent Literature 1: JP-A 2015-188503

However, in the conventional card games, recipe information about powerful decks may be shared among players on the Internet and other such places. As a result, the decks of players all end up being fixed and similar. Because the decks all are alike even if a player changes the opponent, the way the card game unfolds ends up being the same.

### SUMMARY

One or more embodiments of the present invention provide an information processing device with which the game media possessed by players can be more fluid and more diverse. In this way, one or more embodiments of the invention provide a technological improvement over conventional device and method.

An information processing device according to one or more embodiments of the present invention includes a tabulating means for tabulating usage frequency information of game media used by players in a game for each of the game media; an adjustment means for adjusting, for each of the game media and on the basis of usage frequency information about the game media, first and second quantities in a storage that stores a first quantity of game items that players consume in order to put the game media into a possessed state, and a second quantity of game items awarded when players put a possessed game media into a non-possessed state; and an editing means for putting the game media into a player-possessed state by consuming the first quantity of game items from game items owned by a player, and for awarding the second quantity of game items to the items owned by a player when a player puts the game media in a player-possessed state into a non-possessed state.

One or more embodiments of the present invention relate to an information processing device that includes a memory that stores usage frequency of game media used by players for each of the game media, game media in a possessed state for each of the players, a quantity of game items owned by each of the players, first and second quantities of game items for each of the game media. The information processing device further includes a transceiver that receives an input from a terminal device operated by the player. The input causes the game media in the possessed state to be put into a non-possessed state. The information processing device further includes a controller that puts the game media into the possessed state in the memory upon detecting consumption of the first quantity from the quantity. The controller adds the second quantity to the quantity in the memory upon detecting the input received by the transceiver. The controller determines, based on the usage frequency, the first quantity and the second quantity and outputs, to the memory, the first quantity and the second quantity. The lower the usage frequency of the game media, the lower the first quantity and the second quantity.

One or more embodiments of the present invention relate to a method of game processing that includes storing, with a memory of a computer, usage frequency of game media used by players for each of the game media, game media in a possessed state for each of the players, a quantity of game items owned by each of the players, first and second quantities of game items for each of the game media, putting, with a controller of the computer, the game media into a possessed state in the memory upon the controller detecting consumption of the first quantity from the quantity, adding, with the controller, the second quantity to the quantity in the memory upon the controller detecting an input received from a terminal device of the player, an input that causes the game media in the possessed state to be put into a non-possessed state, and determining, with the controller, based on the usage frequency, the first quantity and the second quantity in the memory, The lower the usage frequency of the game media, the lower the first quantity and the second quantity.

One or more embodiments of the present invention relate to an information processing system that includes a terminal device operated by a player in a game and an information processing device that is communicably connected to the terminal device via a network. The terminal device transmits an input operated by the player. The information processing device stores in a memory, usage frequency of game media used by players for each of the game media, game media in a possessed state for each of the players, a quantity of game items owned by each of the players, first and second quantities of game items for each of the game media. The input causes the game media in the possessed state to be put into a non-possessed state. The information processing device puts the game media into the possessed state in the memory upon detecting consumption of the first quantity from the quantity. The information processing device adds the second quantity to the quantity in the memory upon detecting the input transmitted from the terminal device. The information processing device determines, based on the usage frequency, the first quantity and the second quantity. The lower the usage frequency of the game media, the lower the first quantity and the second quantity.

One or more embodiments of the present invention allow the game media possessed by players to be more fluid and more diverse.

### BRIEF DESCRIPTION OF DRAWINGS

FIG. 1 is a configuration diagram of an example of an information processing system according to one or more embodiments of the present invention.

FIG. 2 is a hardware configuration diagram of an example of a computer according to one or more embodiments of the present invention.

FIG. 3 is a processing block diagram of an example of an information processing system according to one or more embodiments of the present invention.

FIG. 4 is a processing block diagram of another example of an information processing system according to one or more embodiments of the present invention.

FIG. 5 is a configuration diagram of an example of card information according to one or more embodiments of the present invention.

FIG. 6 is a configuration diagram of an example of player information according to one or more embodiments of the present invention.

FIG. 7 is a configuration diagram of an example of usage frequency information according to one or more embodiments of the present invention.

FIG. 8 is a flowchart of an example of tabulation processing according to one or more embodiments of the present invention.

FIG. 9 is a configuration diagram of an example of a card originality point table according to one or more embodiments of the present invention.

FIG. 10 is a flowchart of an example of point adjustment processing according to one or more embodiments of the present invention.

FIG. 11 is a table illustrating basic generation points and basic breakup points of card information according to one or more embodiments of the present invention.

FIG. 12 is a table illustrating point adjustment processing according to one or more embodiments of the present invention.

FIG. 13 is a flowchart of an example of card creation processing according to one or more embodiments of the present invention.

FIG. 14 is a conceptual diagram of an example of a card creation screen according to one or more embodiments of the present invention.

FIG. 15 is a conceptual diagram of an example of a card creation screen in which the number of cards to be created is set according to one or more embodiments of the present invention.

FIG. 16 is a conceptual diagram of an example of a card creation screen after creation of a card according to one or more embodiments of the present invention.

FIG. 17 is a flowchart of an example of card breakup processing according to one or more embodiments of the present invention.

FIG. 18 is a conceptual diagram of an example of a ranking screen of card usage frequency points;

FIG. 19 is a conceptual diagram of an example of a card screen according to one or more embodiments of the present invention.

FIG. 20 is a flowchart of an example of deck editing processing according to one or more embodiments of the present invention.

FIG. 21 is a conceptual diagram of an example of a deck editing screen according to one or more embodiments of the present invention.

FIG. 22 is a conceptual diagram of an example of a ranking screen of card usage frequency points;

FIG. 23 is a conceptual diagram of an example of a battle history screen according to one or more embodiments of the present invention.

FIG. 24 is a conceptual diagram of an example of a deck confirmation screen according to one or more embodiments of the present invention.

FIG. 25 is a conceptual diagram of an example of a deck editing screen that has changed from the deck confirmation screen according to one or more embodiments of the present invention.

FIG. 26 is a conceptual diagram of an example of a deck list screen according to one or more embodiments of the present invention.

### DETAILED DESCRIPTION

Embodiments of the present invention will be described in detail below with reference to the drawings. In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

(System Configuration)

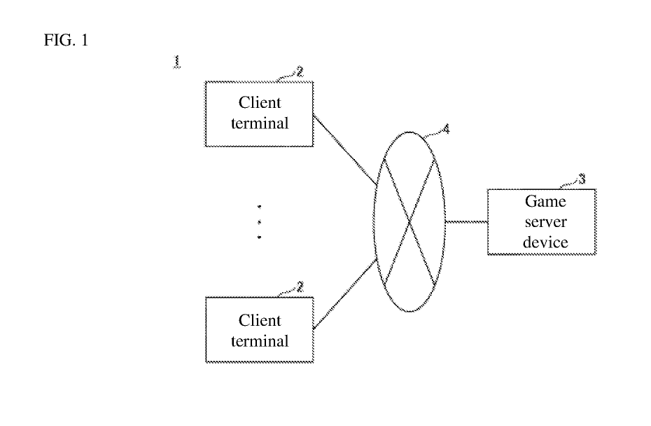

FIG. 1 is a configuration diagram of an example of the information processing system according to one or more embodiments of the present invention. In the information processing system 1 in FIG. 1, one or more client terminals 2 and a game server device 3 are connected via a network 4 such as the Internet.

The client terminals 2 are each a terminal device operated by a player, such as a PC, a smartphone, or a tablet, or a terminal device such as a dedicated gaming device for home or business use. The game server device 3 handles the management and control of the game played by a player on a client terminal 2, billing processing within the game, and so on.

With the information processing system 1 in FIG. 1, one player operating one client terminal 2 and another player operating another client terminal 2 play a card game. In this card game, for example, players summon ally characters by shuffling cards with each other, and repeatedly attack and defend with the characters of their opponent. When one of the players no longer has any hit points (HP), the winner is decided and the battle ends.

The game server device 3 also manages information related to card games played among players. For example, the game server device 3 calculates the usage frequency for each card from information related to the card games played among the players. The game server device 3 causes points consumed in order to generate cards and put them into a possessed state, and points awarded when cards are “broken up” (or “bunkai” as known in the art) into a non-possessed state, to fluctuate as discussed below on the basis of the usage frequency of each card. This fluctuation in points may be performed for either the points consumed in order to generate cards and put them into a possessed state, or the points awarded when cards are broken up into a non-possessed state.

It should go without saying that the information processing system 1 in FIG. 1 is just an example, and there are various system configurations possible according to the application and purpose. For instance, the game server device 3 in FIG. 1 may be configured to be distributed among a plurality of computers.

(Hardware Configuration)

### Client Terminals and Game Server Device

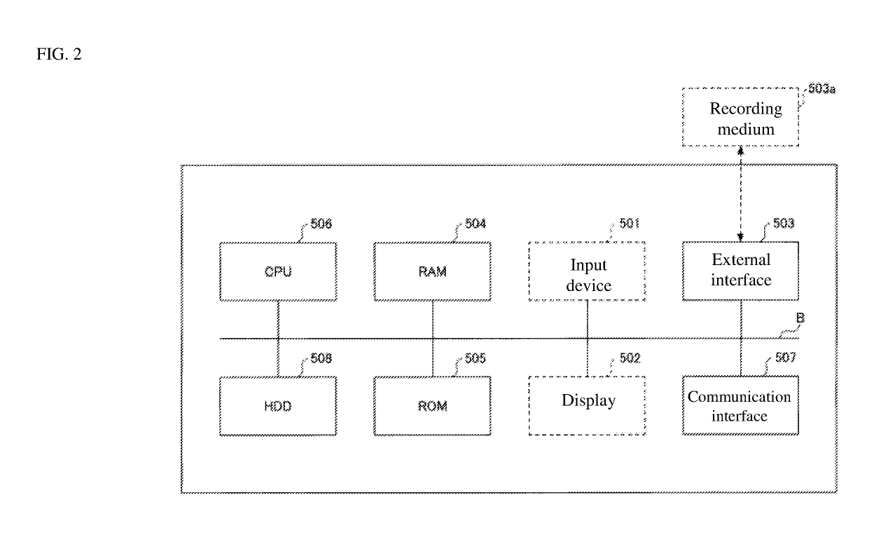

The client terminals 2 and the game server device 3 in FIG. 1 may be realized by a computer with the hardware configuration shown in FIG. 2, for example. FIG. 2 is a hardware configuration diagram of an example of a computer according to one or more embodiments of the present invention.

The computer in FIG. 2 comprises an input device 501, a display 502, an external interface 503, a RAM 504, a ROM 505, a CPU 506, a communication interface 507, a hard disk drive 508, and so forth, which are connected to each other via a bus B. The input device 501 and the display 502 may be configured such that they are connected and used when necessary.

The input device 501 is a touch panel, operation keys and buttons, a keyboard, a mouse, or the like that is used for a player to input various signals. The display 502 is a display such as a liquid crystal or organic electroluminescent display screen. The communication interface 507 is an interface for connecting a computer to the network 4. This allows the computer to perform data communication via the communication interface 507. The communication interface 507 may be referred to as a transceiver or a transmitter/receiver.

The hard disk drive 508 is an example of a nonvolatile storage device that stores programs and data. The programs and data that are stored include an OS, which is the basic software for controlling the entire computer, and applications that provide various functions on the OS.

The computer may make use of a drive device that uses a flash memory as a storage medium (such as a solid state drive: SSD), instead of the hard disk drive 508.

The external interface 503 is an interface with an external device. External devices include a recording medium 503a and the like. This allows the computer 500 to read and/or write from or to the recording medium 503a via the external interface 503. The recording medium 503a may be a flexible disk, a CD, a DVD, an SD memory card, a USB memory, or the like.

The ROM 505 is an example of a nonvolatile semiconductor memory (storage device) that can hold programs and data even if the power is turned off. The ROM 505 stores programs and data such as BIOS and OS settings that are executed when the computer is started up, and network settings. The RAM 504 is an example of a volatile semiconductor memory (storage device) that temporarily holds programs and data.

The CPU 506 is an arithmetic device that realizes the control and function of the entire computer by reading programs and data from a storage device such as the ROM 505 or the hard disk drive 508 onto the RAM 504, and executing processing.

The client terminals 2 and the game server device 3 according to one or more embodiments of the present invention can realize various kinds of processing as described below by executing a program in a computer with the above hardware configuration.

(Software Configuration)

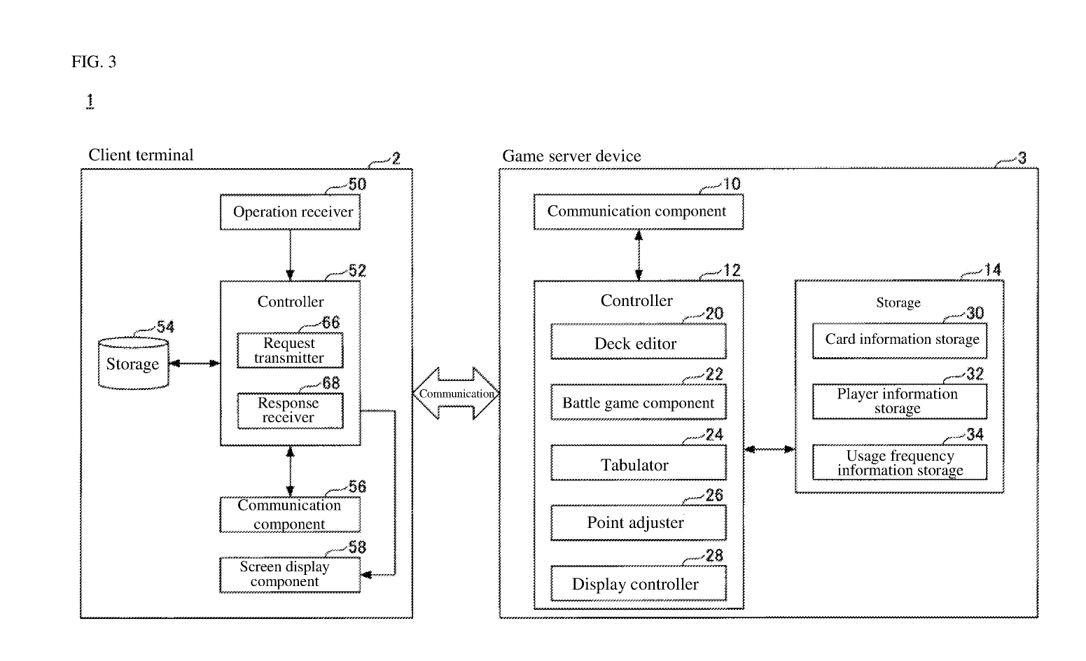

The software configuration of the information processing system 1 according to this embodiment will be described. The information processing system 1 in FIG. 1 may be realized by the processing blocks shown in FIG. 3, for example. FIG. 3 is a processing block diagram of an example of the information processing system according to one or more embodiments of the present invention.

The game server device 3 of the information processing system 1 realizes a communication component 10, a controller 12, and a storage 14 by executing a program. The controller 12 is configured to have a deck editor 20, a battle game component 22, a tabulator 24, a point adjuster 26, and a display controller 28. The storage 14 includes a card information storage 30, a player information storage 32, and a usage frequency information storage 34. The storage 14 may be configured by a memory.

The client terminals 2 of the information processing system 1 each realize an operation receiver 50, a controller 52, a storage 54, a communication component 56, and a screen display component 58 by executing a program. The controller 52 is configured to have a request transmitter 66 and a response receiver 68.

The communication component 10 of the game server device 3 communicates with the client terminals 2. For example, the communication component 10 receives an input from a client terminal 2 operated by a player in the game. The controller 12 performs processing related to the game. The controller 12 causes the game to proceed on the basis of operations received from the players by the client terminals 2. The storage 14 stores information related to the game.

The deck editor 20 of the controller 12 causes the client terminal 2 operated by a player to display a deck editing screen (discussed below). The deck editor 20 receives a deck editing operation (discussed below) from the deck editing screen. For example, the deck editing operation is an operation of building a deck from the list of all the cards possessed by a player.

In a card game, out of all the cards possessed by a player, those cards that constitute the deck can be used in a match. A “deck” is a set of cards (one or more cards grouped together) that a player has put together to play a card game. The maximum number of cards in the deck is usually set. The player builds the deck and plays against other players under the constraint of the maximum number of cards in the deck. In a card game, the building of a deck is an important factor in determining who will win.

The battle game component 22 causes the client terminal 2 operated by the player to display a battle screen, for example. The battle game component 22 receives a battle operation made by the player from the battle screen. An example of a battle screen in a card game and an example of a battle operation on this battle screen are described, for example, in the above-mentioned Patent Literature 1.

The tabulator 24 calculates the usage frequency of each type of card by tabulating the usage count for each type of card (the number of times a card is used by each player in the card game). The point adjuster 26 creates a ranking of usage frequency on the basis of the usage frequency for each type of card. The point adjuster 26 also causes generation points, which are consumed when cards are generated, and “breakup points” (so-called “bunkai points”) which are awarded when cards are broken up, to fluctuate as discussed below on the basis of the ranking of usage frequency. The display controller 28 controls the screen display of the client terminals 2 according to the progress of the game by the controller 12.

The card information storage 30 of the storage 14 stores card information (discussed below). This card information is information related to cards used in battle, and generation points consumed when cards are generated and breakup points awarded when cards are broken up are set for each type of card. The player information storage 32 stores player information related to the player (discussed below). The usage frequency information storage 34 stores the usage frequency for each type of card, and the ranking of this usage frequency, as usage frequency information.

The operation receiver 50 of each client terminal 2 receives an operation from the player operating the client terminal 2. Also, the controller 52 performs processing related to the game at the client terminal 2. The request transmitter 66 of the controller 52 transmits a request to the game server device 3 on the basis of the content of the operation received from the player by the operation receiver 50. The response receiver 68 receives a response such as a processing result for the request transmitted by the request transmitter 66 to the game server device 3.

The storage 54 stores necessary information in the client terminal 2. The communication component 56 performs communication with the game server device 3. The screen display component 58 displays the screen of the client terminal 2 under control by the game server device 3.

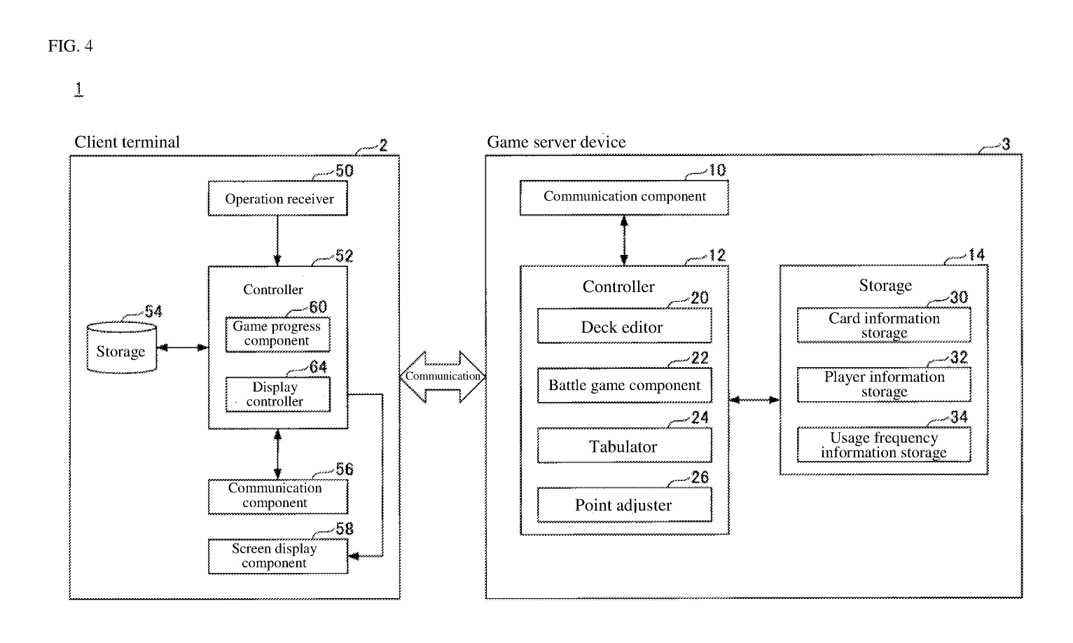

The information processing system 1 in FIG. 1 may be realized by the processing blocks shown in FIG. 4, for example. FIG. 4 is a processing block diagram of another example of the information processing system according to one or more embodiments of the present invention. In the information processing system 1 in FIG. 4, the display controller 28 that was provided to the game server device 3 in the information processing system 1 of FIG. 3 is provided to the controller 52 of the client terminal 2. The information processing system 1 in FIG. 4 is configured such that a game progress component 60 is added to the controller 52 of the client terminal 2.

The game progress component 60 of the client terminal 2 performs processing related to the game, and allows the game to proceed on the basis of operations received from the player. The display controller 64 controls the screen display of the client terminal 2 according to the progress of the game by the controller 52.

As shown in FIG. 3 or FIG. 4, the information processing system 1 according to one or more embodiments of the present invention may perform game progress or display control on the client terminal 2 or on the game server device 3. The information processing system 1 according to one or more embodiments of the present invention may be configured such that at least some of the components of the game server device 3 are provided to another server device besides the game server device 3, or to the client terminal 2.

The controller 52 of the client terminal 2 is a browser-type device that performs processing related to the game by receiving page data written in HTML (Hyper Text Markup Language) or the like, scripts included in page data, or the like from the game server device 3. The controller 52 of the client terminal 2 may also be an application type, in which processing related to the game is performed on the basis of an installed application.

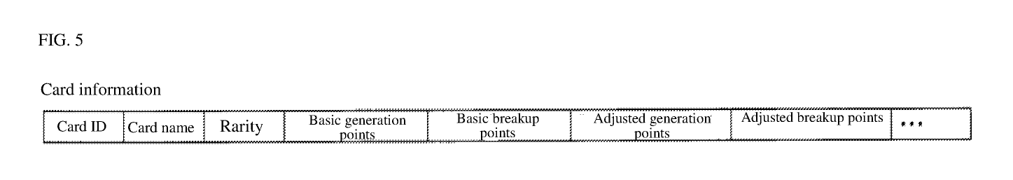

The card information storage 30 of the storage 14 stores card information as shown in FIG. 5, for example. FIG. 5 is a configuration diagram of an example of card information. Categories of the card information in FIG. 5 include card ID, card name, rarity, basic generation points, basic breakup points, adjusted generation points, and adjusted breakup points.

Card ID is an example of identification information for uniquely identifying the type of card. Card name is the name of the card. Rarity is information indicating the ranking of the card. Basic generation points are the basic value of the generation points consumed when a card is generated, and are the generation points before adjustment. Basic breakup points are the basic value of the breakup points awarded when a card is broken up, and are the breakup points before adjustment.

Adjusted generation points are the generation points obtained by adjusting the basic generation points on the basis of the ranking of the usage frequency of the card. Adjusted breakup points are the breakup points obtained by adjusting the basic breakup points on the basis of the ranking of the usage frequency of the card. Generation points consumed when a player generates a card may be adjusted generation points. Also, breakup points awarded when a player breaks up a card may be adjusted breakup points.

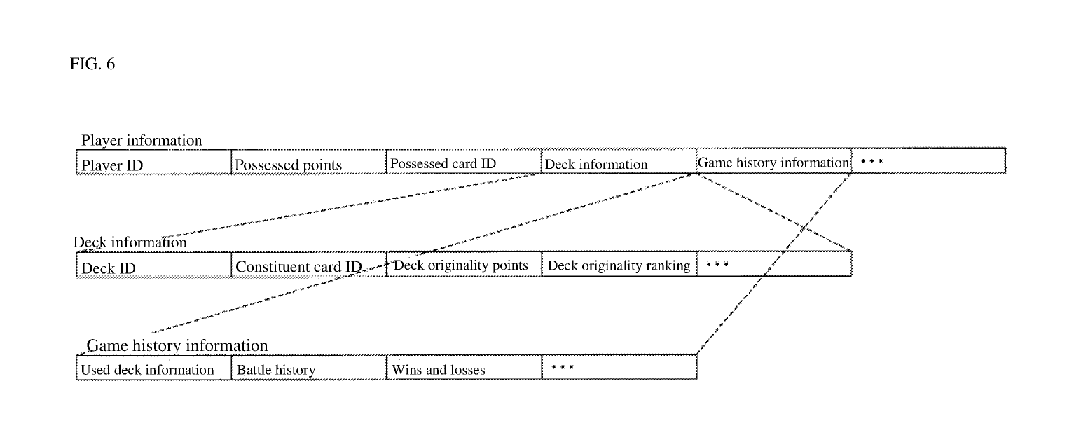

The player information storage 32 of the storage 14 stores player information as shown in FIG. 6, for example. FIG. 6 is a configuration diagram of an example of player information. Categories of the player information in FIG. 6 include player ID, possessed points, possessed card ID, deck information, and game history information.

Player ID is an example of identification information for uniquely identifying the player. Possessed points indicate the number of points possessed by the player. The possessed points decrease by an amount equal to the generation points when the player generates a card. The possessed points increase by an amount equal to the breakup points when the player breaks up a card. Thus, the controller 12 puts the card into the possessed state in the storage 14 when the controller 12 detects consumption of the generation points from the points possessed by the player. The controller 12 adds the breakup points to the points possessed by the player in the storage 14 when the controller 12 detects an input that causes the card in the possessed state to put into a non-possessed state.

Possessed card ID is an example of information indicating the card ID of the cards in the player's possession (in a possessed state). Deck information is an example of information indicating decks built by the player. Game history information is an example of information about the game history of the player.

For example, deck information shown in FIG. 6 has categories of deck ID, constituent card ID, deck originality points, and deck originality ranking. Player information shown in FIG. 6 may have one or more sets of deck information. Deck ID is an example of identification information for uniquely identifying the deck. Constituent card ID is an example of information indicating the card ID of the cards that constitute the deck. Deck originality points are an index of the deck's uniqueness and originality. For instance, the deck originality points are represented by the total value of the card originality points of the cards that constitute the deck. Card originality points are an index of the degree of originality of a card; a card with a lower ranking of usage frequency will have higher points, and a card having a higher ranking of usage frequency will have lower points. Deck originality ranking is the ranking of the deck given according to the deck originality points.

Also, categories of the game history information shown in FIG. 6 include used deck information, battle history, and wins and losses, for example. Game history information is history information about games which the player has played using the deck. Used deck information included in the game history information is information about the deck used by the player for the game, and is used for tabulating the card usage count, as will be discussed below.

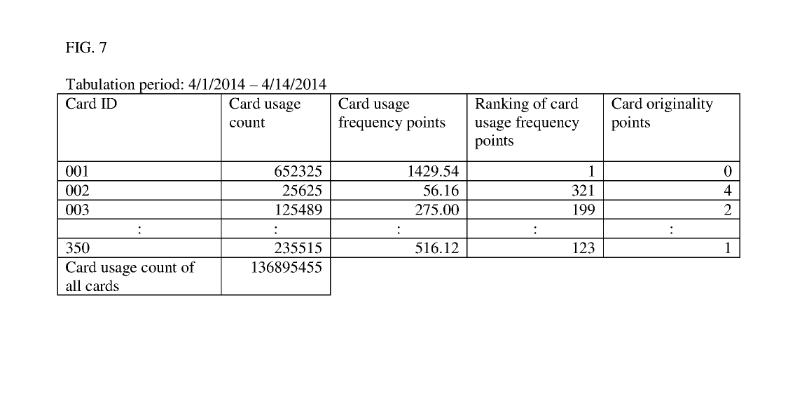

The usage frequency information storage 34 of the storage 14 stores usage frequency information as shown in FIG. 7, for example. FIG. 7 is a configuration diagram of an example of usage frequency information. Categories of the usage frequency information in FIG. 7 include card ID, card usage count, card usage frequency points, ranking of card usage frequency points, and card originality points.

Card ID is an example of identification information for uniquely identifying the type of card. Card usage count is the count obtained by counting how many times a card has been used by a player during a specific tabulation period (such as a week or a month). In one or more embodiments of the present invention, the use of a card means that a card is put into a deck and a game is played with that deck.

For example, the usage frequency information in FIG. 7 indicates that the card with the card ID “001” was used “652,325” times by all the players during the tabulation period. When two or more cards of the same type are put in the deck and used, the card usage count is tabulated for the number of cards included.

Card usage frequency points are the point value of the card usage count; the greater is the card usage count, the higher are the points. The card usage frequency points can be calculated by the following equation (1), for example. A specific value is multiplied in order to abstract the card usage frequency points.

Card usage frequency points=Specific value×Card usage count÷Total card usage count (1)

Ranking of the card usage frequency points indicates the rank order of the card usage frequency points. The higher are the card usage frequency points, the higher is the ranking. In other words, the ranking increases in proportion to the card usage count, and also decreases in proportion to the card usage count.

Card originality points are an index indicating the originality of a card. The card originality points are determined by the ranking of the card usage frequency points; the higher is the ranking of a card (the higher is the usage frequency of the card), the lower are these points, and the lower is the ranking of a card (the lower is the usage frequency of the card), the higher are these points.

(Processing)

(Tabulation Processing)

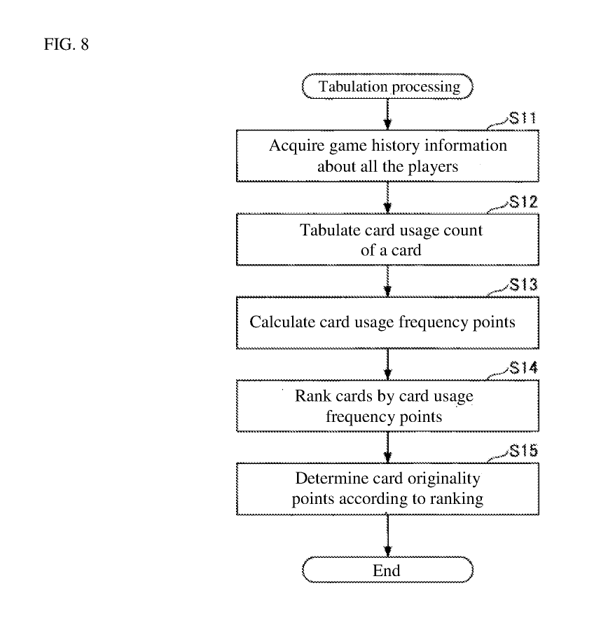

The usage frequency information in FIG. 7 is created by the tabulation processing in FIG. 8, for example. FIG. 8 is a flowchart of an example of tabulation processing. The tabulation processing in FIG. 8 is executed by the elapse of a specific tabulation period, for example.

In step S11, the tabulator 24 of the game server device 3 acquires game history information about all the players from the player information in FIG. 6, which is stored in the player information storage 32. The acquired game history information includes information about the deck used by the player in the game.

In step S12, the tabulator 24 tabulates the card usage count of each card during the specific tabulation period from the acquired game history information. The card usage count is the count obtained by counting how many times each card has been used by all the players during a specific tabulation period. The card usage count of the usage frequency information in FIG. 7 is inputted by the processing of step S12.

In step S13, the tabulator 24 calculates the card usage frequency points for each card according to the above-mentioned equation (1). The card usage frequency points of the usage frequency information in FIG. 7 are inputted by the processing of step S13.

In step S14, the tabulator 24 ranks the cards according to the card usage frequency points calculated in step S13. The ranking of the card usage frequency points in FIG. 7 is inputted by the processing of step S14. For example, the ranking of the card usage frequency points in FIG. 7 shows an example in which the ranking increases in proportion to the number of card usage frequency points, or in other words, increases in proportion to the card usage count.

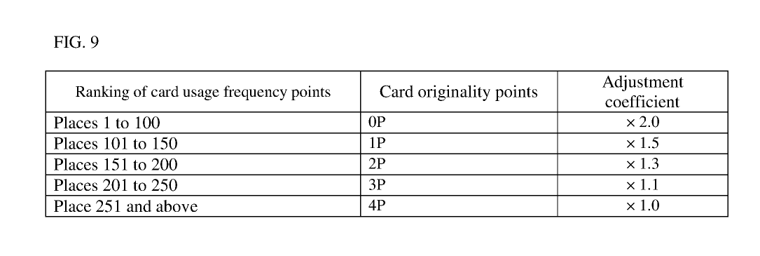

In step S15, the tabulator 24 acquires the card originality points corresponding to the ranking of the card usage frequency points performed in step S14, from the card originality point table in FIG. 9, for example. FIG. 9 is a configuration diagram of an example of a card originality point table. The card originality point table in FIG. 9 is a table in which the ranking of the card usage frequency points is associated with the card originality points and an adjustment coefficient.

In the card originality point table of FIG. 9, the higher is the ranking of the card usage frequency points, or in other words, the more frequently the players use a card, the lower are set the card originality points. Also, in the card originality point table of FIG. 9, the lower is the ranking of the card usage frequency points, or in other words, the less frequently the players use a card, the higher are set the card originality points. The card originality points in FIG. 7 are inputted by the processing of step S15.

The tabulation processing of FIG. 8 makes it possible for the tabulator 24 to recognize those cards that are used the most by the players (are the most popular among the players) and those cards that are not used that often (are the least popular among the players), from the card usage count in a specific tabulation period. In addition, the tabulation processing of FIG. 8 makes it possible for the tabulator 24 to assign low card originality points to cards that are frequently used by the players and assign high card originality points to cards that are not used by the players that often.

(Point Adjustment Processing)

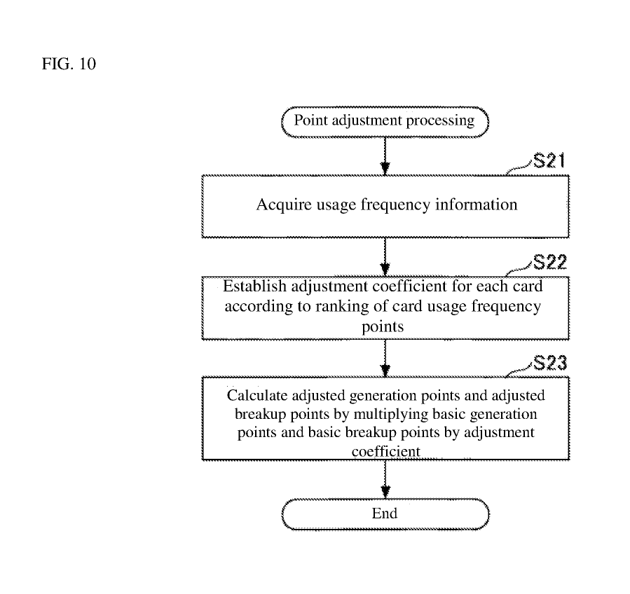

The adjusted generation points and adjusted breakup points of the card information in FIG. 5 are created by the point adjustment processing in FIG. 10, for example. FIG. 10 is a flowchart of an example of point adjustment processing. The point adjustment processing in FIG. 10 is executed after the tabulation processing in FIG. 8, for example.

In step S21, the point adjuster 26 of the game server device 3 acquires the usage frequency information in FIG. 7, for example, from the usage frequency information storage 34. In step S22, the point adjuster 26 acquires the ranking of the card usage frequency points for each card from the acquired usage frequency information. The point adjuster 26 acquires an adjustment coefficient for each card according to the ranking of the acquired card usage frequency points, from the card originality point table shown in FIG. 9, for example.

In the card originality point table in FIG. 9, the higher is the ranking of the card usage frequency points of a card, or in other words, the more frequently that card is used by the players, the higher is set the adjustment coefficient. Also, in the card originality point table of FIG. 9, the lower is the ranking of the card usage frequency points of a card, or in other words, the less frequently that card is used by the players, the lower is set the adjustment coefficient.

In step S23, the point adjuster 26 acquires the card information in FIG. 5, for example, from the card information storage 30. The point adjuster 26 acquires the basic generation points and the basic breakup points for each card from the card information in FIG. 5, and multiplies these by the adjustment coefficient for each card to calculate the adjusted generation points and the adjusted breakup points. The adjusted generation points and adjusted breakup points of the card information in FIG. 5 are inputted by the processing of step S23.

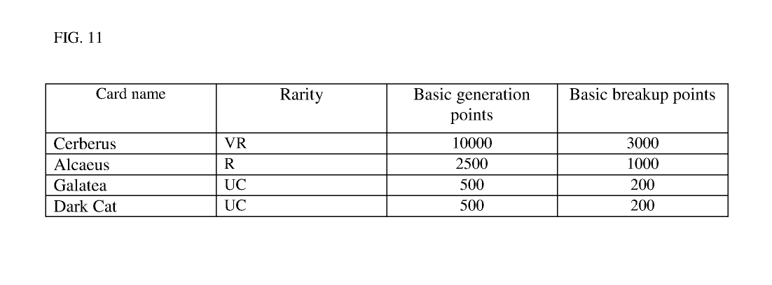

The point adjustment processing will be further described. FIG. 11 is a table illustrating basic generation points and basic breakup points of card information. As shown in FIG. 11, basic generation points and basic breakup points are set for each card. The basic generation points and the basic breakup points in FIG. 11 show examples in which the basic values of the generation points and the breakup points are determined according to the rarity of each card.

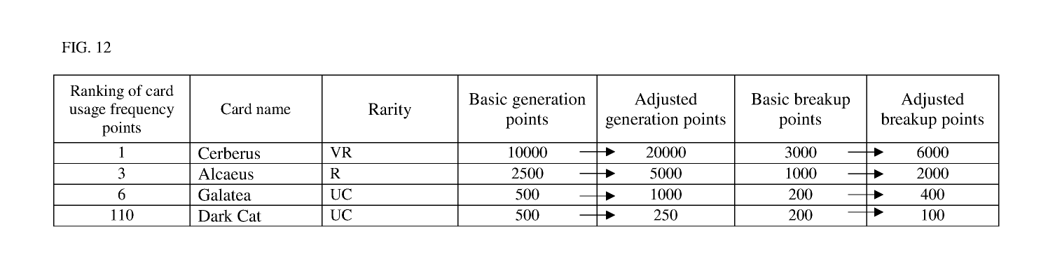

FIG. 12 is a table illustrating point adjustment processing. The ranking of the card usage frequency points for each card shown in FIG. 12 is determined as a result of the tabulation processing in FIG. 8. In the example in FIG. 12, the rankings of the card usage frequency points of the top three cards are all within the top ten, and their usage rate by players is high. Also, in the example in FIG. 12, the ranking of the card usage frequency points of the bottom card is 110^{th} place, and its usage rate by players is low.

In one or more embodiments of the present invention, the result of the point adjustment processing in FIG. 10 is that the adjusted generation points and the adjusted breakup points of the top three cards having a high player usage rate are adjusted to twice the basic generation points and the basic breakup points. Generation is suppressed by increasing the number of generation points consumed when generating a card with a high player usage rate. Also, breakup is promoted by increasing the number of breakup points awarded when breaking up a card with a high player usage rate. As a result, in one or more embodiments of the present invention, it is possible to reduce the number of players having cards with high usage rates and to suppress the use of cards with high usage rates.

Also, in one or more embodiments of the present invention, the result of the point adjustment processing in FIG. 10 is that the adjusted generation points and the adjusted breakup points of the bottom card having a low player usage rate are adjusted to one half of the basic generation points and the basic breakup points. Generation is promoted by reducing the number of generation points consumed when generating a card with a low player usage rate. Also, breakup is suppressed by reducing the number of breakup points awarded when breaking up a card having a low player usage rate. As a result, in one or more embodiments of the present invention, it is possible to increase the number of players having cards with low usage rates and to promote the use of cards with low usage rates.

Thus, in one or more embodiments of the present invention, an environment in which cards that are popular based on their ranking of card usage frequency points tend to be broken up, and cards that are not popular tend to be generated, is realized by adjusting the generation points and the breakup points. With a configuration such as this, in one or more embodiments of the present invention, it is possible to construct an environment in which decks that are in fashion tend to circulate.

(Card Creation Processing)

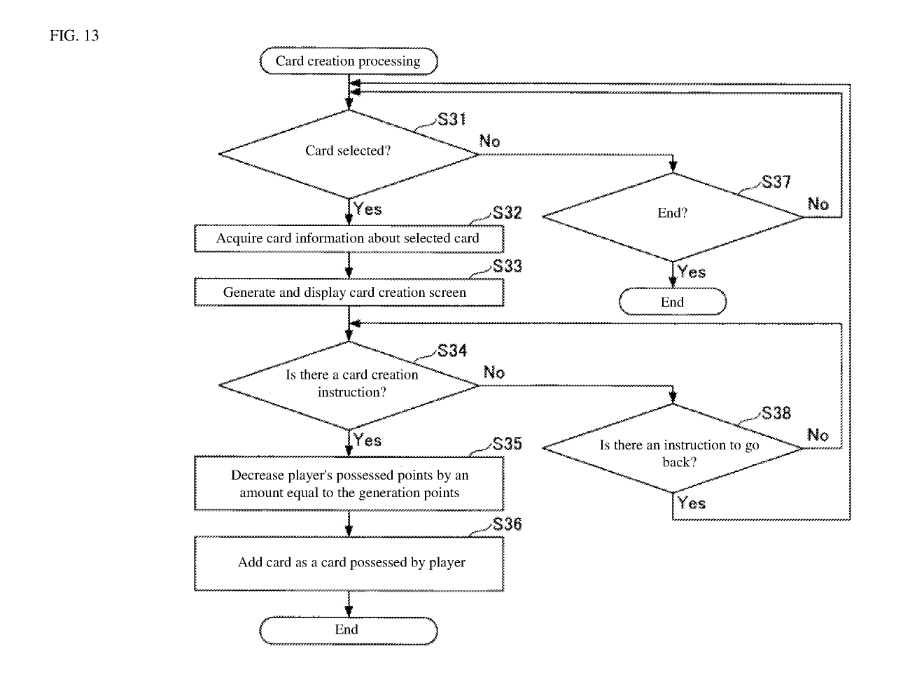

The deck editor 20 of the game server device 3 performs card creation processing according to instructions from the players, and by the procedure shown in FIG. 13, for example. FIG. 13 is a flowchart of an example of card creation processing.

When a card is selected by a player, the deck editor 20 proceeds from step S31 to step S32 and acquires card information about the card selected by the player from the card information storage 30.

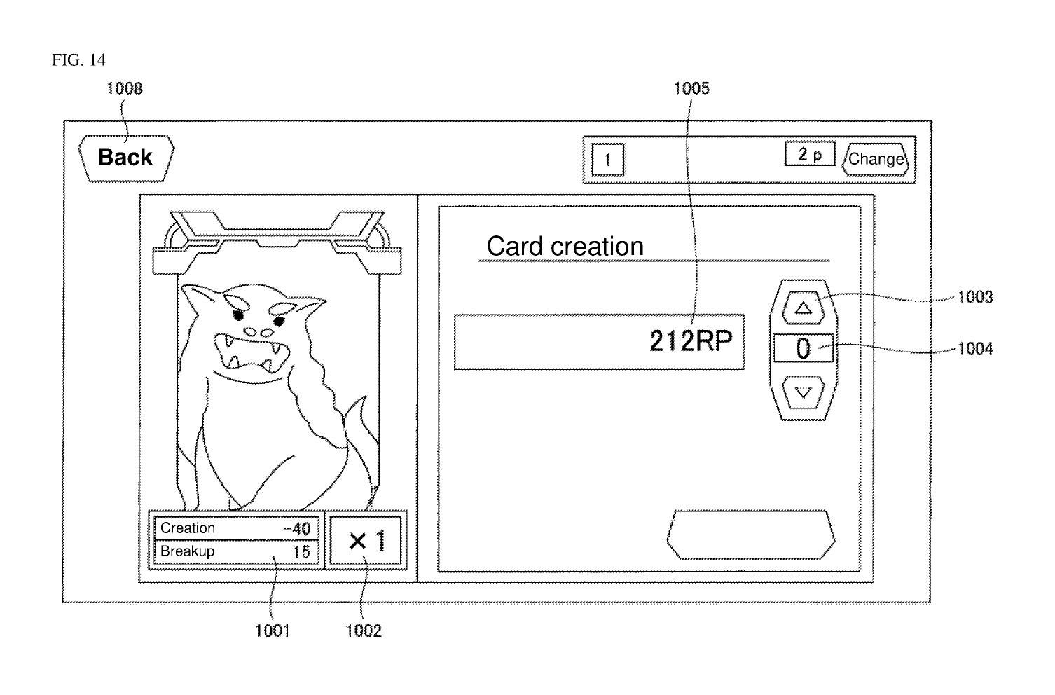

In step S33, the deck editor 20 generates the card creation screen shown in FIG. 14, for example, from the card information acquired in step S32, and causes the client terminal 2 to display this screen. FIG. 14 is conceptual diagram of an example of a card creation screen. The card creation screen in FIG. 14 is configured to have a generation and breakup point display field 1001, a possessed card count display field 1002, a creation card count increase button 1003, a creation card count display field 1004, a possessed point display field 1005, and a back button 1008. The player can use the card creation screen in FIG. 14 to confirm the generation points and breakup points for the selected card and the possessed card count, and to confirm the current possessed points.

FIG. 14 shows an example of a card creation screen in which the adjusted generation points and the adjusted breakup points are displayed as generation points and breakup points in the generation and breakup point display field 1001, but the basic generation points and the basic breakup points may be displayed along with these other points as well.

Thus displaying the basic generation points and the adjusted generation points in the generation and breakup point display field 1001 of the card generation screen makes it easy for the player to recognize whether or not creating this card at the present time would be advantageous or disadvantageous. A mark indicating whether the current adjusted generation points are greater or less than the basic generation points, numerical information based on the point difference between the adjusted generation points and the basic generation points, or other such information may also be displayed in the generation and breakup point display field 1001 of the card generation screen, so that the player can tell whether it is currently advantageous or disadvantageous to create that card.

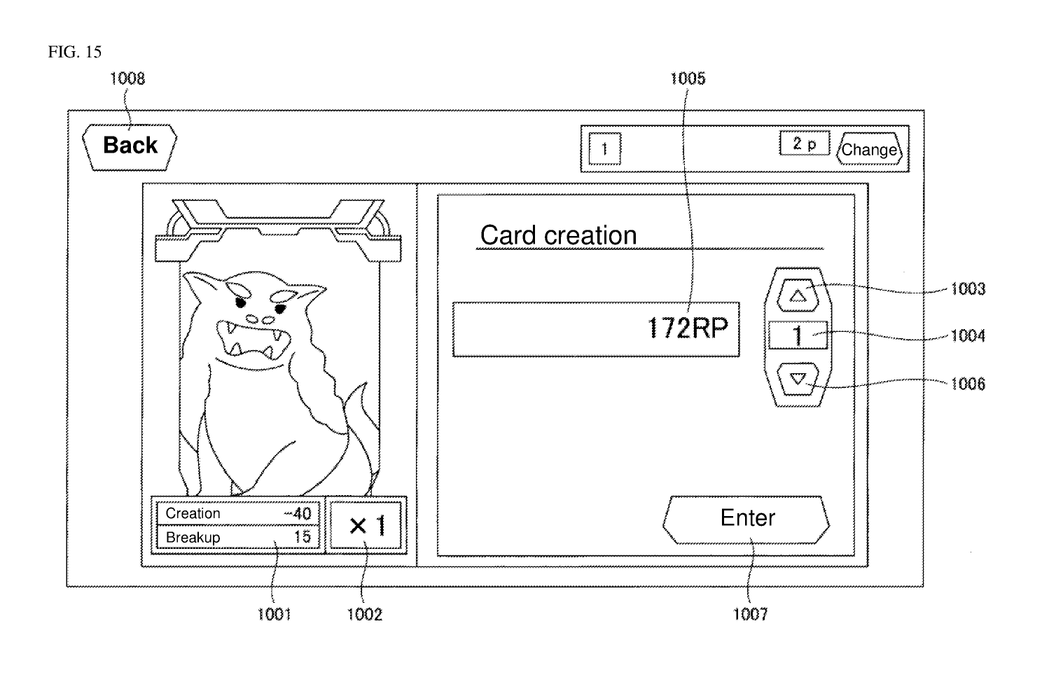

If the creation card count increase button 1003 on the card creation screen in FIG. 14 is operated and the creation card count displayed in the creation card count display field 1004 is set to one or more cards, a creation card count decrease button 1006 and an enter button 1007 are displayed, as in the card creation screen in FIG. 15. FIG. 15 is a conceptual diagram of an example of a card creation screen in which the creation card count has been set. The player can issue a card creation instruction by performing an operation of pressing the enter button 1007 on the client terminal 2.

Upon receiving a card creation instruction from the player, the deck editor 20 proceeds to step S35 and decreases the possessed points of the player information in FIG. 6 corresponding to the player, by an amount equal to the generation points. The deck editor 20 proceeds to step S36 and adds the card for which the card creation instruction was issued to the possessed card ID of the player information in FIG. 6, as a card possessed by the player.

If there is an end instruction from the player in step S37, the deck editor 20 ends the card creation processing in FIG. 13. Also, in step S38, upon receiving an operation in which the player presses the back button 1008, the deck editor 20 returns to the processing of step S31.

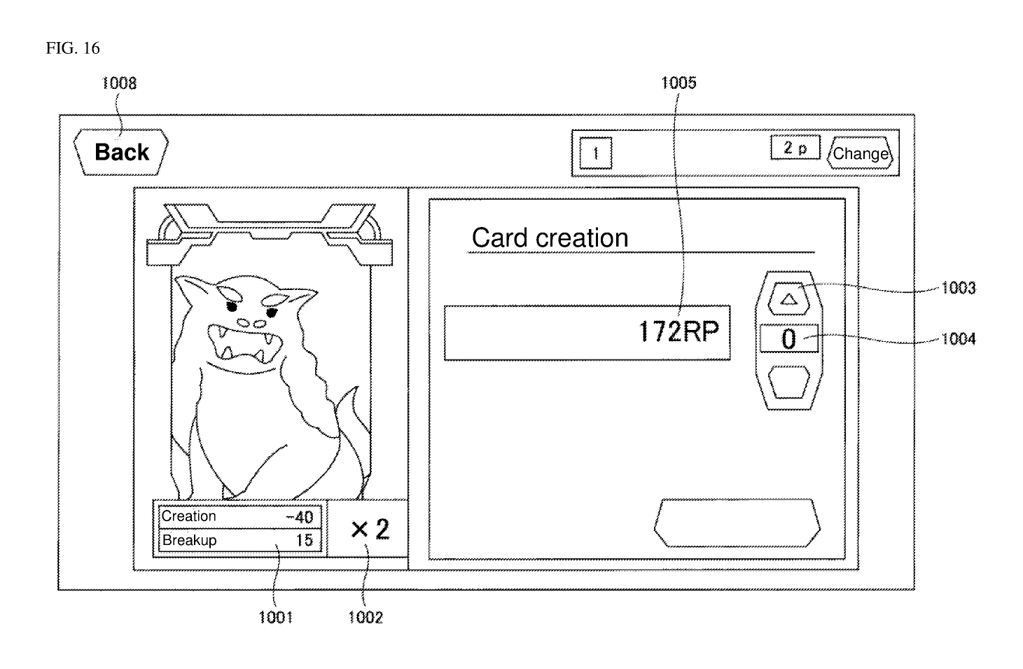

When a card is created by the card creation processing in FIG. 13, the card creation screen in FIG. 15 changes into the creation screen in FIG. 16. FIG. 16 is a conceptual diagram of an example of a card creation screen after creation of a card. On the card creation screen in FIG. 16, the possessed card count in the possessed card count display field 1002 has been updated from 1 to 2 by the creation of a card.

(Card Breakup Processing)

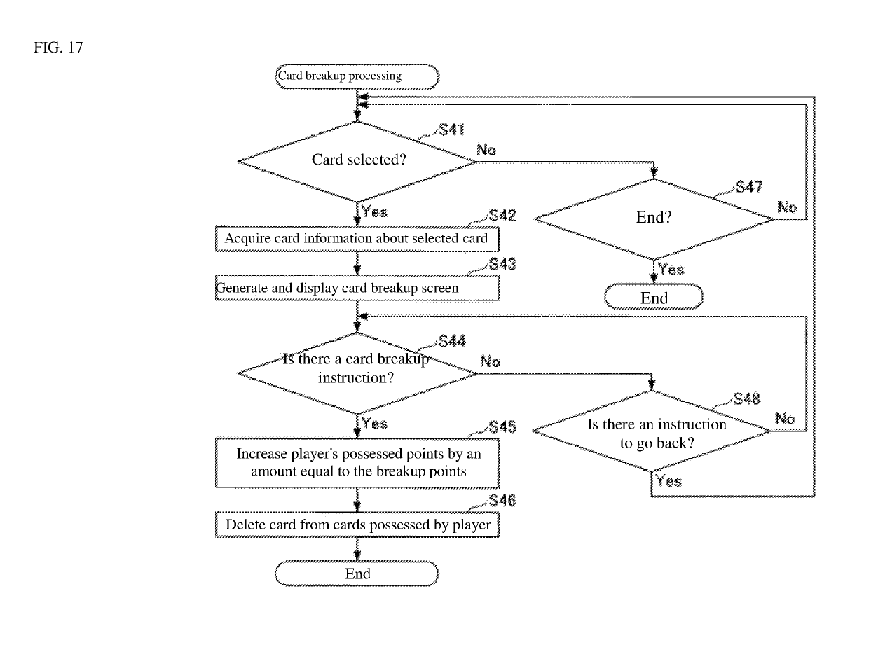

The deck editor 20 of the game server device 3 performs card breakup processing according to instructions from the players, and by the procedure shown in FIG. 17, for example. FIG. 17 is a flowchart of an example of card breakup processing.

When a card is selected by the player, the deck editor 20 proceeds from step S41 to step S42 and acquires card information about the card selected by the player from the card information storage 30.

In step S43, the deck editor 20 generates a card breakup screen from the card information acquired in step S42, and causes the client terminal 2 to display this screen. For example, the card breakup screen is configured to have a generation and breakup point display field, a possessed card count display field, a breakup card count increase button, a breakup card count display field, a possessed point display field, and a back button. The player can use the card breakup screen to confirm the generation points and breakup points of the selected card and the possessed card count, and to confirm the current possessed points.

On the card breakup screen, the adjusted generation points and the adjusted breakup points may be displayed as generation points and breakup points in the generation and breakup point display field, or the basic generation points and the basic breakup points may also be displayed together with these other points, for example.

Thus displaying the basic breakup points and the adjusted breakup points in the generation and breakup point display field of the card breakup screen makes it easy for the player to recognize whether or not breaking up this card at the present time would be advantageous or disadvantageous. A mark indicating whether the current adjusted breakup points are greater or less than the basic breakup points, numerical information based on the point difference between the adjusted breakup points and the basic breakup points, or other such information may also be displayed in the generation and breakup point display field of the card generation screen, so that the player can tell whether it is currently advantageous or disadvantageous to break up that card.

If the breakup card count increase button on the card breakup screen is operated and the breakup card count displayed in the breakup card count display field is set to one or more cards, a breakup card count decrease button and an enter button are displayed. The player can issue a card breakup instruction by performing an operation of pressing the enter button on the client terminal 2.

Upon receiving a card breakup instruction from the player, the deck editor 20 proceeds to step S45 and increases the possessed points of the player information in FIG. 6 corresponding to the player, by an amount equal to the breakup points. The deck editor 20 proceeds to step S46 and deletes the card ID for which a card breakup instruction was issued from the possessed card IDs of the player information in FIG. 6, so the card for which the breakup instruction was issued can be deleted from the possessed card of the player.

If there is an end instruction from the player at step S47, the deck editor 20 ends the card breakup processing in FIG. 17. Upon receiving an operation of pressing the back button from the player in step S48, the deck editor 20 returns to the processing of step S41. When a card is broken up by the card breakup processing in FIG. 17, the possessed card count in the possessed card count display field of the card creation screen is updated to a number that is smaller by an amount equal to the number of broken up cards.

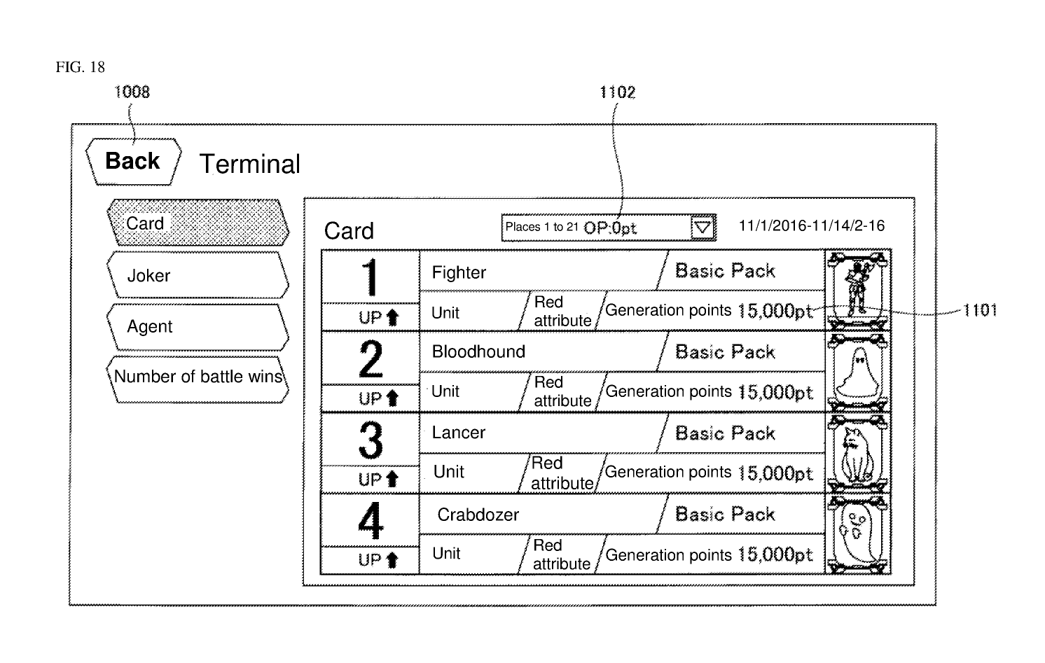

The card selection in step S31 of FIG. 13 and step S41 of FIG. 17 may be accomplished by having the player select from a list of cards, for example, or by having the player select from a ranking screen of card usage frequency points as shown in FIG. 18, for example.

FIG. 18 is a conceptual diagram of an example of the ranking screen of card usage frequency points. The ranking screen of card usage frequency points shown in FIG. 18 is configured to display at least some of the card rankings, and to have a generation point display field 1101 for each card, and a card originality point display field 1102. FIG. 18 shows an example of displaying the cards having first to fourth-place rankings of card usage frequency points, the generation point display fields 1101 for those cards, and the card originality point display field 1102 for the first to twenty-first rankings of card usage frequency points.

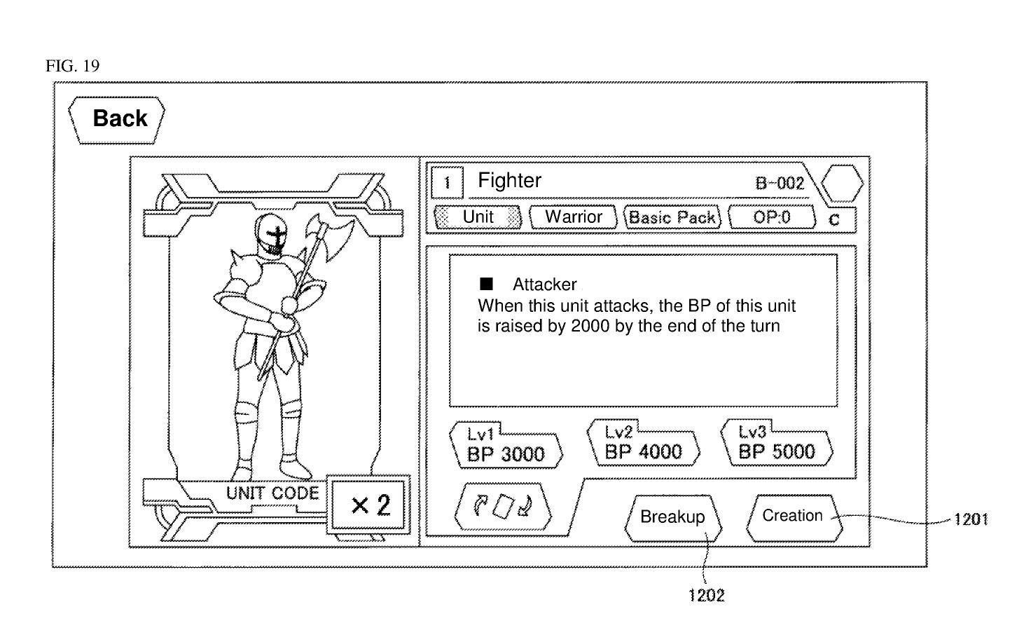

When the player selects a card from the ranking screen of the card usage frequency points in FIG. 18 by tapping or another such operation, the deck editor 20 of the game server device 3 displays the card screen shown in FIG. 19, for example. FIG. 19 is a conceptual diagram of an example of a card screen. The card screen shown in FIG. 19 is configured to have a card creation button 1201 and a card breakup button 1202. The player can display a card creation screen by performing an operation of pressing the card creation button 1201 on the card screen. The player can also display a card breakup screen by performing an operation of pressing the card breakup button 1202 on the card screen.

(Deck Editing Processing)

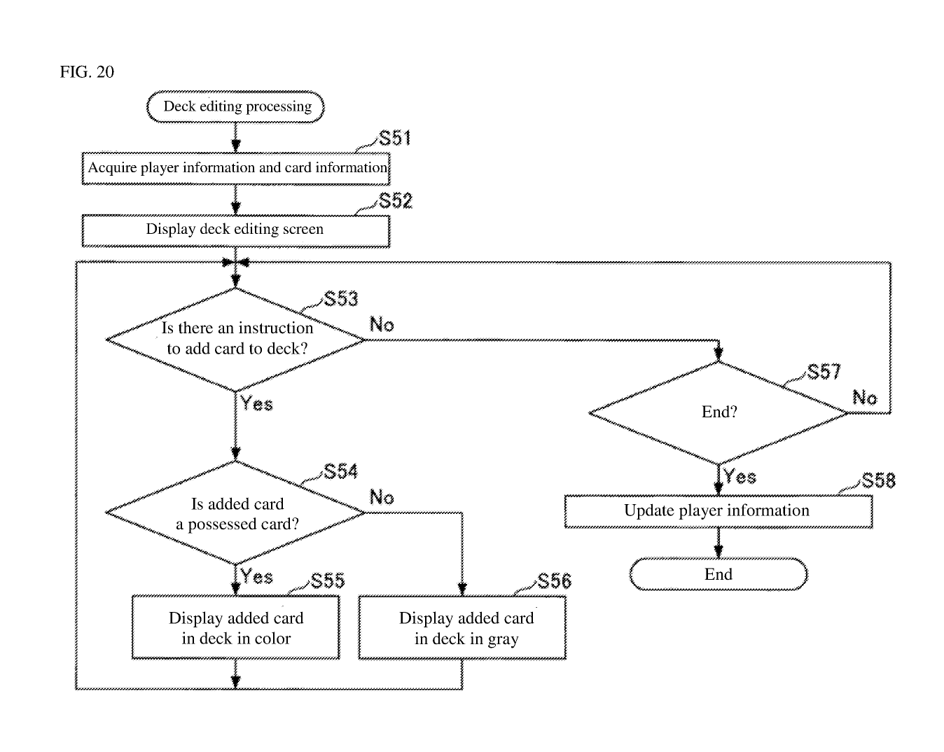

The deck editor 20 of the game server device 3 performs deck editing processing according to instructions from the players, and by the procedure shown in FIG. 20, for example. FIG. 20 is a flowchart of an example of deck editing processing.

When deck editing is selected by a player, the deck editor 20 acquires card information from the card information storage 30 in step S51 and acquires player information from the player information storage 32.

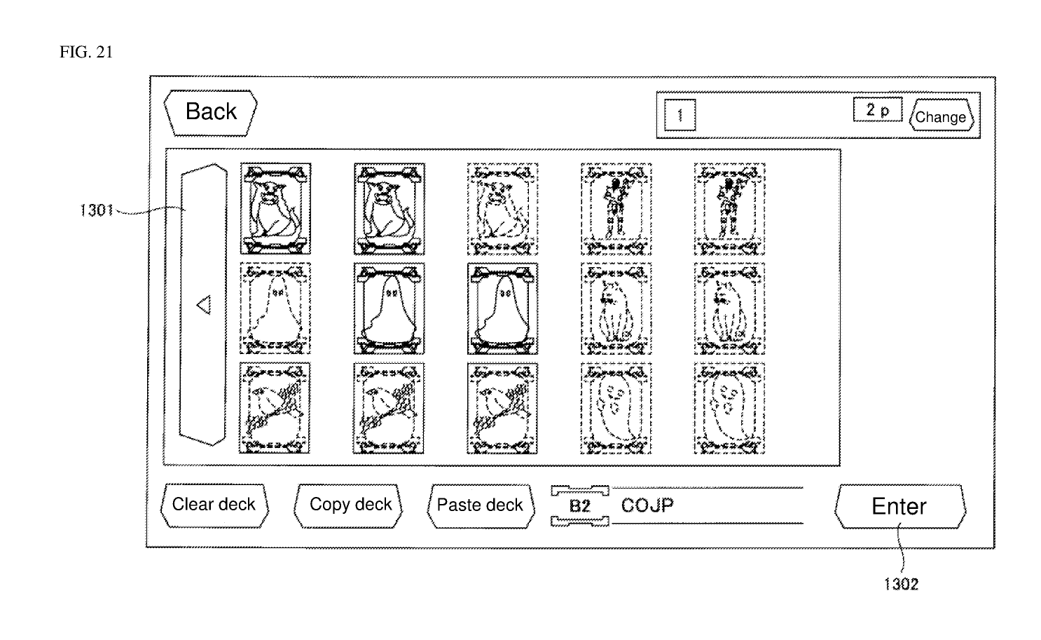

In step S52, the deck editor 20 acquires the card IDs of the cards that constitute the player's deck from the constituent card IDs included in the deck information of the player information acquired in step S51. Then, the deck editor 20 displays the cards corresponding to the card IDs as a list as shown in FIG. 21, for example.

FIG. 21 is a conceptual diagram of an example of a deck editing screen. The deck editing screen in FIG. 21 shows a deck built by the player from one or more cards, and the display allows the player to visually distinguish between cards he possesses and cards he does not possess, from among all the cards included in the deck. For instance, on the deck editing screen, cards possessed by the player are displayed in color and cards not possessed by the player are displayed in gray. On the deck editing screen in FIG. 21, cards displayed in gray are indicated by dotted lines for the sake of convenience.

The addition of cards to the deck or deletion of cards from the deck can be accomplished from the card selection screen displayed on the client terminal 2 by pressing a card selection screen change button 1301, for example. On the card selection screen, for example, an operation of selecting a card from the card list to be added to the deck, and an operation of deleting a card from the card list included in the deck are received from the player. The player can end the deck editing processing by pressing an enter button 1302.

Upon receiving an instruction to add a card to the deck from the player, the deck editor 20 proceeds to step S54 and determines whether the card for which the addition instruction was issued is a card possessed by the player. If it is a possessed card, the deck editor 20 proceeds to step S55 and displays the card for which the addition instruction was issued in color on the deck editing screen of FIG. 21. If, however, the card for which the addition instruction was issued is not a card possessed by the player, the deck editor 20 proceeds to step S56 and displays that card in gray on the deck editing screen.

When there is an instruction from the player to end the deck editing processing, the deck editor 20 proceeds to step S58 to update the constituent card ID, the deck originality points, and the deck originality ranking included in the deck information of the player information, and the deck editing processing in FIG. 20 is ended.

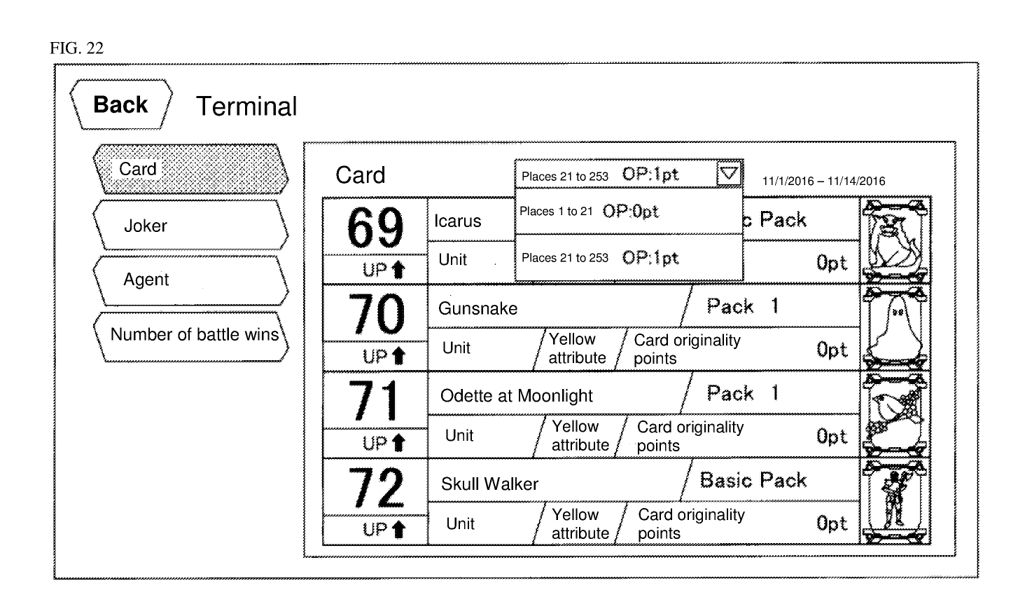

The card selection screen displayed on the client terminal 2 by pressing the card selection screen change button 1301 may, for example, be a ranking screen of card usage frequency points as shown in FIG. 22.

(Deck Copy Processing)

The deck editor 20 of the game server device 3 may be designed so that an opponent's deck can be copied (discussed below) according to an instruction from the player. For example, in one or more embodiments of the present invention, deck information about the deck used by an opponent is stored in the game history information of the player information. Also, in one or more embodiments of the present invention, the decks used not only by an opponent but also by other players may be copied. For example, the deck information may be linked with the replay information from when the deck was used. Consequently, after watching the replay of a player who is better than him, the player can easily build the same deck as that player.

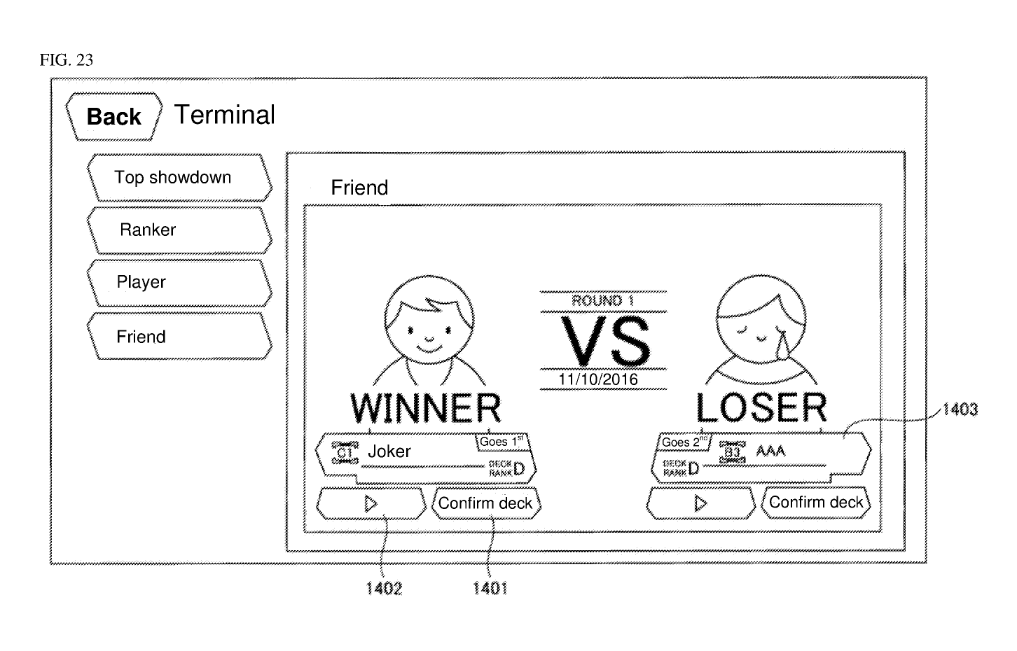

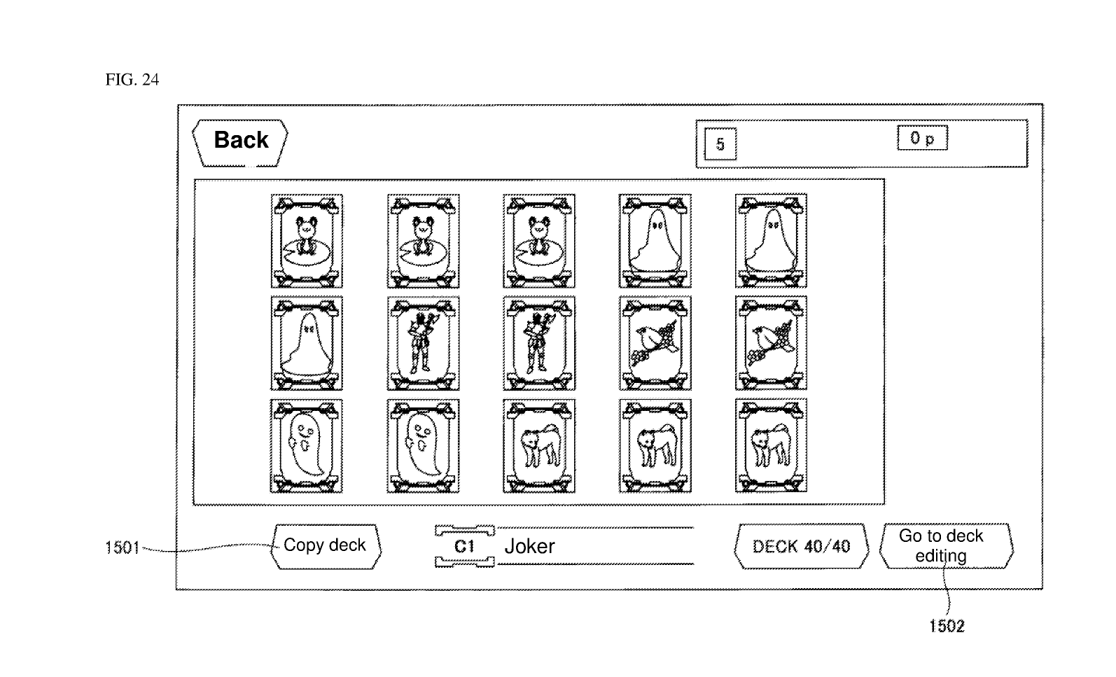

The player selects one battle history from among past battle histories, and displays the battle history screen shown in FIG. 23, for example. FIG. 23 is a conceptual diagram of an example of a battle history screen. The player can confirm the deck used by the opponent in a battle on the deck confirmation screen shown in FIG. 24, for example, by pressing a deck confirmation button 1401 on the battle history screen shown in FIG. 23. The player can view a replay between the opponent and the player by press the playback button 1402 in FIG. 23. The opponent information 1403 in FIG. 23 displays information pertaining to the opponent, such as the opponent's name and ranking, the strength of the deck used by the opponent, and so forth.

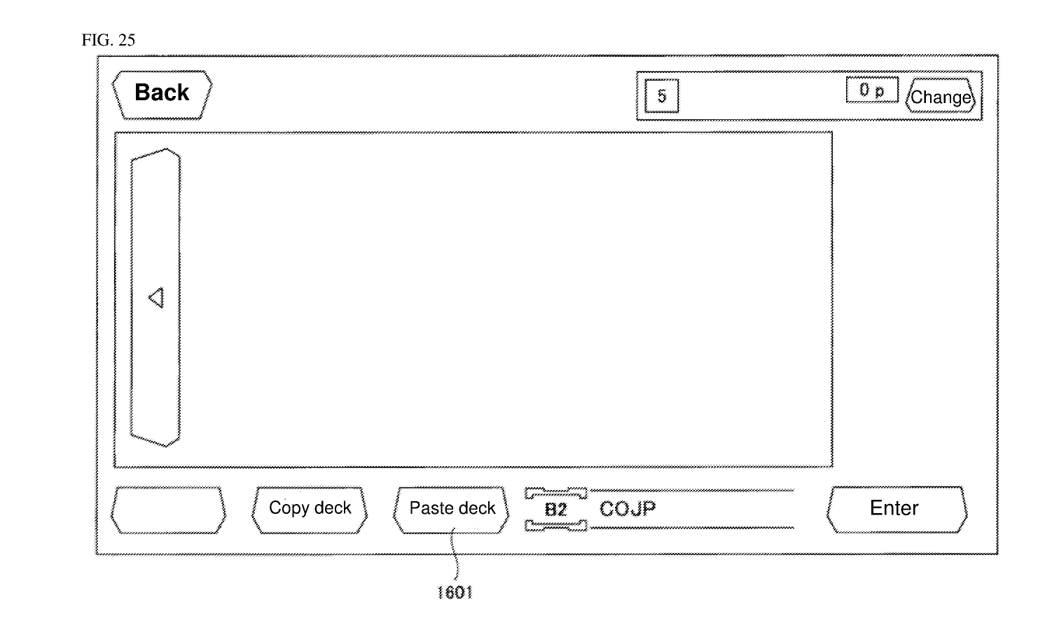

FIG. 24 is a conceptual diagram of an example of a deck confirmation screen. On the deck confirmation screen in FIG. 24, a list of the cards included in the deck used by the opponent player is displayed. The player can copy the opponent's deck by pressing a deck copy button 1501 on the deck confirmation screen in FIG. 24. The player can also display the deck editing screen shown in FIG. 25 on the client terminal 2 by pressing a deck edit button 1502 on the deck confirmation screen in FIG. 24.

FIG. 25 is a conceptual diagram of an example of a deck editing screen that has changed from the deck confirmation screen. The player can paste the opponent's deck onto the deck editing screen by pressing a deck paste button 1601 on the deck editing screen in FIG. 25. The deck pasted onto the deck editing screen in FIG. 25 is displayed such that cards possessed by the player and cards not possessed can be visually distinguished, just as with the deck editing screen in FIG. 21.

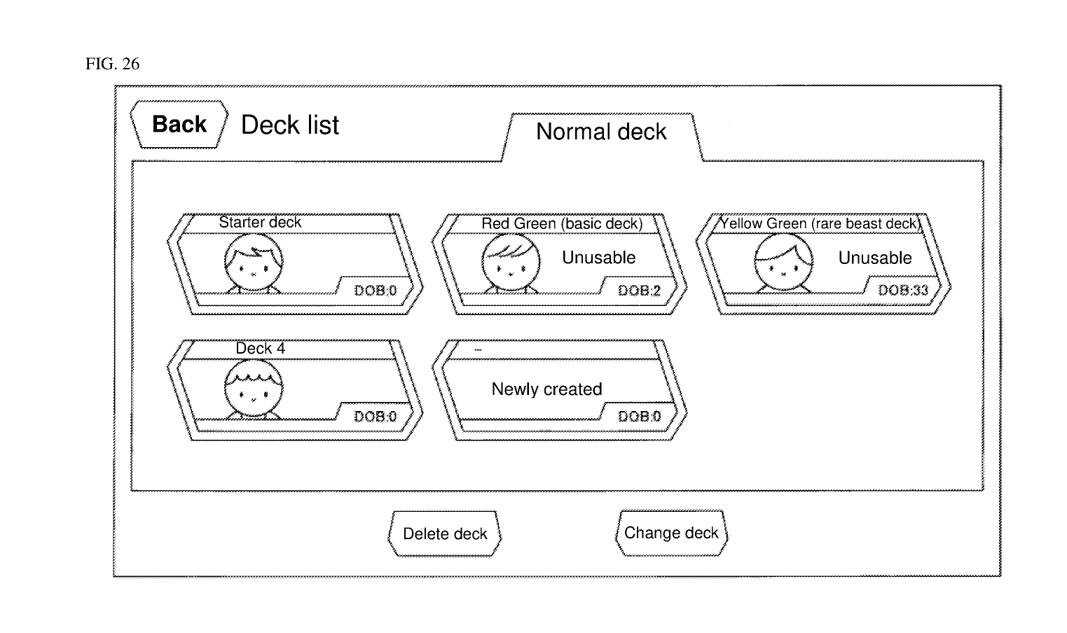

In this way, in one or more embodiments of the present invention, the player can build a deck including even cards not possessed by the player. However, since a deck including cards not possessed by the player cannot be used, the fact that the deck is unusable is clearly indicated on the deck list screen in FIG. 26, for example. FIG. 26 is a conceptual diagram of an example of a deck list screen. The player can select the deck to be used for battle from the deck list screen shown in FIG. 26.

With the deck list screen in FIG. 26, it is possible to easily set up decks that the player thinks he may want to use in the future, even though these decks cannot be used because they include cards the player does not possess. Also, in one or more embodiments of the present invention, the configuration may be such that, of the cards constituting the deck, the adjusted generation points of cards not possessed and the possessed points of the player are monitored, and the player is notified when the player's possessed points go over the adjusted generation points of cards not possessed, drop under the first quantity determined on the basis of the previous tabulation, and/or drop under the first quantity at the point when a group of game media is set.

In one or more embodiments of the present invention, cards that are in fashion can be made to circulate well by varying the generation points consumed to generate a card and the breakup points awarded when a card is broken up, on the basis of the ranking of the usage frequency of the cards that make up the deck. As a result, the cards possessed by players can be made more fluid, and the cards possessed by players will be less likely to be the same.

In one or more embodiments of the present invention, an example of a card game (battle-type trading card game) played against other players was described, but the present invention can also be broadly applied to games played using cards possessed by the players. Also, in one or more embodiments of the present invention, an example was described in which a card is generated by consuming the possessed points of the player, and a card is broken up so that possessed points are awarded, but the present invention can also be applied to a lottery (so-called “gacha”) performed in a game by consuming the possessed points of the player.

For example, with a game in which a lottery is provided for each attribute of an item or a character, the attributes of items and characters possessed by players can be kept from all ending up being the same by setting a high price for a gacha having a popular attribute and setting a low price for a gacha having an unpopular attribute.

The present invention is not limited to embodiments specifically disclosed above, and various modifications and changes are possible without departing from the scope of the claims. Cards are an example of the game media, and the present invention can also be applied to game characters, weapons, and the like. Possessed points are an example of game items. Generation points are an example of a first quantity. Breakup points are an example of a second quantity. A deck is an example of a group of game media.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.
1 information processing system
2 client terminal
3 game server device
4 network
10, 56 communication component
12, 52 controller
14, 54 storage
20 deck editor
22 battle game component
24 tabulator
26 point adjuster
28 display controller
30 card information storage
32 player information storage
34 usage frequency information storage
50 operation receiver
58 screen display component
60 game progress component
64 display controller
66 request transmitter
68 response receiver
501 input device
502 display
503 external interface
503a recording medium
504 RAM
505 ROM
506 CPU
507 communication interface
508 hard disk drive
1001 generation and breakup point display field
1101 generation point display field
1102 card originality point display field
1201 card creation button
1202 card breakup button
1401 deck confirmation button
1501 deck copy button
1502 deck edit button
1601 deck paste button
B bus

What is claimed is:

1. An information processing device, comprising:
a memory that stores:
usage frequency of game media used by players in a game, for each of the game media;
game media in a possessed state for each of the players;
a quantity of game items owned by each of the players;
a first quantity of game items for each of the game media; and
a second quantity of game items for each of the game media;
a transceiver that receives an input from a terminal device operated by a player, wherein the input causes the game media in the possessed state to be put into a non-possessed state; and
a controller that:
puts the game media into the possessed state in the memory upon detecting consumption of the first quantity from the quantity,
adds the second quantity to the quantity in the memory upon detecting the input received by the transceiver,
determines, based on the usage frequency, the first quantity and the second quantity, and
outputs, to the memory, the first quantity and the second quantity,
wherein, the lower the usage frequency of the game media, the lower the first quantity and the second quantity.

2. The information processing device according to claim 1, wherein, the higher the usage frequency of the game media, the higher the first quantity and the second quantity.

3. The information processing device according to claim 1,
wherein the controller tabulates the usage frequency for each of the game media, and
wherein the controller outputs, to the memory, the tabulated usage frequency.

4. The information processing device according to claim 3,
wherein, upon receiving, from the terminal device, a group setting for the game media used by the player, the controller causes the memory to store the received group setting, and
wherein the controller causes a screen of the terminal device to display the game media in the possessed state and the game media in the non-possessed state that are visually distinguished, and
wherein the screen is a screen on which the player performs the group setting of the game media.

5. The information processing device according to claim 4,
wherein, when a predetermined period has elapsed, the controller repeatedly tabulates the usage frequency in the predetermined period, and
wherein the transceiver notifies the player when the determined first quantity in a non-possessed state included in the group falls under at least one of:
the quantity;
the first quantity determined based on of a previous tabulation; and
the first quantity of when the group of game media was set.

6. A method of game processing comprising:
storing, with a memory of a computer:
usage frequency of game media used by players in a game, for each of the game media;
game media in a possessed state for each of the players;
a quantity of game items owned by each of the players;
a first quantity of game items for each of the game media; and
a second quantity of game items for each of the game media;
putting, with a controller of the computer, the game media into a possessed state in the memory upon the controller detecting consumption of the first quantity from the quantity,
adding, with the controller, the second quantity to the quantity in the memory upon the controller detecting an input received from a terminal device of the player that causes the game media in the possessed state to be put into a non-possessed state; and
determining, with the controller, based on the usage frequency, the first quantity and the second quantity in the memory,
wherein, the lower the usage frequency of the game media, the lower the first quantity and the second quantity.

7. The method according to claim 6, wherein, the higher the usage frequency of the game media, the higher the first quantity and the second quantity.

8. The method according to claim 6, further comprising:
tabulating, with the controller, the usage frequency for each of the game media, and
outputting, from the controller to the memory, the tabulated usage frequency.

9. The method according to claim 8,
upon receiving, from the terminal device, a group setting for the game media used by the player, causing, with the controller, the memory to store the received group setting, and
causes, with the controller, a screen of the terminal device to display the game media in the possessed state and the game media in the non-possessed state that are visually distinguished, and
wherein the screen is a screen on which the player performs the group setting of the game media.

10. The method according to claim 9,
wherein, when a predetermined period has elapsed, the tabulating repeatedly tabulates the usage frequency in the predetermined period, and
the method further comprising:
notifying the player when the determined first quantity in a non-possessed state included in the group falls under at least one of:
the quantity;
the first quantity determined based on of a previous tabulation; and
the first quantity of when the group of game media was set.

11. An information processing system comprising:
a terminal device operated by a player in a game; and
an information processing device that is communicably connected to the terminal device via a network,
wherein the information processing device stores in a memory:
usage frequency of game media used by players in a game, for each of the game media;
game media in a possessed state for each of the players;
a quantity of game items owned by each of the players;
a first quantity of game items for each of the game media; and
a second quantity of game items for each of the game media,
wherein the terminal device transmits an input operated by the player,
wherein the input causes the game media in the possessed state to be put into a non-possessed state,
wherein the information processing device puts the game media into the possessed state in the memory upon detecting consumption of the first quantity from the quantity, and
wherein the information processing device adds the second quantity to the quantity in the memory upon detecting the input transmitted from the terminal device,
wherein the information processing device determines, based on the usage frequency, the first quantity and the second quantity, and
wherein, the lower the usage frequency of the game media, the lower the first quantity and the second quantity.

12. The information processing system according to claim 11, wherein, the higher the usage frequency of the game media, the higher the first quantity and the second quantity.

13. The information processing system according to claim 1,
wherein the information processing device tabulates the usage frequency for each of the game media, and
wherein the information processing device stored, in the memory, the tabulated usage frequency.

14. The information processing system according to claim 13,
wherein when the information processing device receives, from the terminal device, a group setting for the game media used by the player, the information processing device causes the memory to store the received group setting, and
wherein the information processing device causes a screen of the terminal device to display the game media in the possessed state and the game media in the non-possessed state that are visually distinguished, and
wherein the screen is a screen on which the player performs the group setting of the game media.

15. The information processing system according to claim 14,
wherein, when a predetermined period has elapsed, the information processing device repeatedly tabulates the usage frequency in the predetermined period, and
wherein the information processing device notifies the terminal device when the determined first quantity in a non-possessed state included in the group falls under at least one of:
the quantity;
the first quantity determined based on of a previous tabulation; and
the first quantity of when the group of game media was set.
